(19) United States
(12) Patent Application Publication
(10) Pub. No.: US 2026/0310342 A1
(43) Pub. Date: Oct. 8, 2026

(54) GENERATIVE AI WORKFLOWS FOR MANAGEMENT OF DATA SETTINGS

(71) Applicant: Kinaxis Inc., Ottawa (CA)

(72) Inventors: Bradley Duck, Ottawa (CA); David Strenge, Ottawa (CA); Emily Mahnly Ong, Ottawa (CA); Artsiom Biba, Ottawa (CA); Danilo Teixeira Pontes, Ottawa (CA); Nicolas Belland, Ottawa (CA)

(73) Assignee: Kinaxis Inc., Ottawa, ON (CA)

(21) Appl. No.: 19/641,015

(22) Filed: Apr. 7, 2026

Related U.S. Application Data
(60) Provisional application No. 63/785,292, filed on Apr. 8, 2025.

(51) Int. Cl. G06F 3/04847; G06N 3/0475

(52) U.S. Cl. CPC G06F 3/04847; G06N 3/0475

(57) ABSTRACT

Systems and methods for managing data settings of a software platform includes receiving, via a user interface, a natural-language request from a user. The natural-language request is processed with a routing model to select, from among multiple available workflows, a workflow corresponding to an intended user action. Based on the selected workflow, a corresponding tool is invoked. A machine-learning model generates tool output using the natural-language request and tool-specific instruction content associated with the corresponding tool. The software platform performs the selected workflow based on the tool output and provides, through the user interface, an output corresponding to the performed workflow. In some embodiments, the available workflows include a data settings workflow, a settings summarization workflow, and a resource access workflow.

This application claims priority on U.S. Ser. No. 63/785,292 filed on Apr. 8, 2025, which is incorporated herein in its entirety, by reference.

### BACKGROUND

In some platforms, the data settings panels and toolbars are some of the most complicated pieces of the front-end of the platform. As such, the user experience is quite complex, and poses a significant barrier to users. These panels and toolbars require extensive training to use and to understand. In order to effectively navigate data settings management, users need to perform a large number of manual actions. Unfortunately, existing frameworks do not allow for unstructured input (that is, natural language text/voice).

Modern data management platforms often use complex Graphical User Interfaces (GUIs) to configure data settings, query parameters, and system behavior. These interfaces show up as dense panels, layered toolbars, and nested menus that force users through many steps to reach a desired setup. They are often rigid and assume operators understand the data schema, available algorithms, and system constraints. As a result, users must follow manual workflows: choose options from lists, toggle switches, and enter values in fixed fields. This creates cognitive load because users must translate business goals into low-level technical settings, resulting in more time and expertise needed to make changes.

This complexity is a barrier for non-technical users and adds overhead for administrators. Because the interface logic is hard-coded, it rarely supports unstructured inputs like natural language or voice. Users must follow fixed workflows, often jumping across screens to find the right setting. That drives training needs and increases the chance of errors. Without a conversational way to state intent, even simple changes can take too long, resulting in higher training cost and slower day-to-day work.

Data server and client-server architectures usually prioritize backend performance—execution speed, retrieval, and resource use—over easy configuration. Tools for external data sources, caching, and cross-environment compute still assume users can navigate complex User Interfaces (UIs). Work like external calculations and federated queries often requires setting many detailed parameters in the same panels. Since the system cannot interpret unstructured intent, users rely on memorized click paths. As features expand, the UI grows too, which increases training needs and reduces usability. As a result, usability drops as complexity increases.

There is a need for a technical solution that allows a user to effectively manage complex data settings without any extensive prior training

### BRIEF SUMMARY

Systems and methods disclosed herein, provide an opportunity for a technical solution that leverages Large Language Models (LLMs) to process natural language input and allow a user to effectively manage data settings without any extensive prior training. The system includes a processor and memory storing instructions to receive a user query, process the query through an LLM router, determine an appropriate action or workflow, invoke a respective tool, and provide an output on a platform interface. The implementation can involve the following steps: receive an initial user query via text or voice through a chat interface on a landing page or inside resources; process the query through an LLM router to determine the most appropriate action or workflow; invoke a specific tool based on the selected action, where tools can include a data settings tool, a summarize tool, or an open resource tool. For the data settings tool, LLM can be called with a system prompt describing changeable settings to return parsed settings changes such as setting equals Scenario and value equals Approved Actions. For the summarize tool, the LLM can be called with a system prompt describing each setting to summarize the current settings state as natural language. For the open resource tool, the LLM can be called with a system prompt specifying how to open a user resource such as name equals Planning Sheet and type equals Workbook. A final step is to provide the output to the user via the platform interface after handlers perform the actions and reply in the web client chat.

An LLM router can interpret natural-language requests and map them to executable workflows, reducing the need for complex, menu-driven UIs and extensive training. An orchestrator can route system prompts to the right tools based on meaning, then convert user intent into precise actions (for example, updating settings or summarizing the current state). This cuts manual steps, lowers cognitive load, and makes advanced features easier to use, resulting in faster configuration with fewer clicks and less training.

Furthermore, a data security layer that sends only the minimum prompt content reduces privacy risk and can improve latency in cloud-based LLM calls. It limits exposure of sensitive configuration details while keeping the interface responsive. With one chat interface, users can trigger tools for updates, state summaries, and resource access, improving efficiency and accessibility without sacrificing data integrity, resulting in lower risk and better response times.

Disclosed herein is a technical solution using LLMs to process natural language input for managing data settings, that includes specific technical features (for example, an LLM router, processor, memory, specific tool invocation logic, and the like) that enhance the technical implementation of the system.

In one aspect, a computing apparatus is provided, that includes a processor. The computing apparatus also includes a memory storing instructions that, when executed by the processor, configure the apparatus to: receive, via a user interface of a software platform, a user input includes a natural-language request; process the natural-language request with a routing model to determine, from among a plurality of available workflows, a selected workflow corresponding to an intended action of the user; based on the selected workflow, invoke a tool associated with the selected workflow; generate, with a machine-learning model using the natural-language request and tool-specific instruction content associated with the tool, a tool output representing information for execution of the selected workflow; cause the software platform to perform the selected workflow based on the tool output; and provide, via the user interface, an output corresponding to the performed selected workflow.

The computing apparatus may also include where the plurality of available workflows includes a data settings workflow, a settings summarization workflow, and a resource access workflow. The computing apparatus may also include where the routing model is configured: to select the data settings workflow when the natural-language request indicates a requested change to at least one data setting, to select the settings summarization workflow when the natural-language request indicates a requested summary of a current settings state, and to select the resource access workflow when the natural-language request indicates a requested opening of a user resource.

The computing apparatus may also include where the tool-specific instruction content describes how the machine-learning model is to format the tool output for the selected workflow. When generating the tool output, the apparatus may also be configured to transmit to the machine-learning model a minimum prompt content sufficient to perform the selected workflow. When causing the software platform to perform the selected workflow, the apparatus may also be configured to pass the tool output to one or more handlers that execute the selected workflow through one or more application programming interface endpoints of the software platform. When generating the tool output, the apparatus may also be configured to transmit to the machine-learning model a minimum prompt content sufficient to perform the selected workflow. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive, via a user interface of a software platform, a user input includes a natural-language request; process the natural-language request with a routing model to determine, from among a plurality of available workflows, a selected workflow corresponding to an intended action of the user; based on the selected workflow, invoke a tool associated with the selected workflow; generate, with a machine-learning model using the natural-language request and tool-specific instruction content associated with the tool, a tool output representing information for execution of the selected workflow; cause the software platform to perform the selected workflow based on the tool output; and provide, via the user interface, an output corresponding to the performed selected workflow.

The non-transitory computer-readable storage medium may also include where the plurality of available workflows includes a data settings workflow, a settings summarization workflow, and a resource access workflow. The non-transitory computer-readable storage medium may also include where the routing model is configured: to select the data settings workflow when the natural-language request indicates a requested change to at least one data setting, to select the settings summarization workflow when the natural-language request indicates a requested summary of a current settings state, and to select the resource access workflow when the natural-language request indicates a requested opening of a user resource.

The non-transitory computer-readable storage medium may also include where the tool-specific instruction content describes how the machine-learning model is to format the tool output for the selected workflow. When generating the tool output, the computer may be configured to transmit to the machine-learning model a minimum prompt content sufficient to perform the selected workflow. When causing the software platform to perform the selected workflow, the computer may be configured to: pass the tool output to one or more handlers that execute the selected workflow through one or more application programming interface endpoints of the software platform. When generating the tool output, the computer may be configured to transmit to the machine-learning model a minimum prompt content sufficient to perform the selected workflow. Other technical features may be readily apparent to one skilled in the art from the following figures, descriptions, and claims.

In one aspect, a computer-implemented method for managing data settings of a software platform, the method includes: receiving, via a user interface of the software platform, a user input includes a natural-language request; processing the natural-language request with a routing model to determine, from among a plurality of available workflows, a selected workflow corresponding to an intended action of the user; based on the selected workflow, invoking a tool associated with the selected workflow; generating, with a machine-learning model using the natural-language request and tool-specific instruction content associated with the tool, a tool output representing information for execution of the selected workflow; causing the software platform to perform the selected workflow based on the tool output; and provide, via the user interface, an output corresponding to the performed selected workflow.

The computer-implemented method may also include where the plurality of available workflows includes a data settings workflow, a settings summarization workflow, and a resource access workflow. The computer-implemented method may also include where the routing model is configured: to select the data settings workflow when the natural-language request indicates a requested change to at least one data setting, to select the settings summarization workflow when the natural-language request indicates a requested summary of a current settings state, and to select the resource access workflow when the natural-language request indicates a requested opening of a user resource.

The computer-implemented method may also include where the tool-specific instruction content describes how the machine-learning model is to format the tool output for the selected workflow. The computer-implemented method may also include where generating the tool output includes transmitting to the machine-learning model a minimum prompt content sufficient to perform the selected workflow. The computer-implemented method may also include where causing the software platform to perform the selected workflow includes passing the tool output to one or more handlers that execute the selected workflow through one or more application programming interface endpoints of the software platform. The computer-implemented method may also include where generating the tool output includes transmitting to the machine-learning model a minimum prompt content sufficient to perform the selected workflow. Other technical features may be readily apparent to one skilled in the art from the following figures, descriptions, and claims.

In one aspect, a computing apparatus is provided that includes a processor. The computing apparatus also includes a memory storing instructions that, when executed by the processor, configure the apparatus to: receive, via a user interface, a natural-language request associated with at least one data setting of a software platform; provide the natural-language request to a machine-learning model; receive, from the machine-learning model, a structured output corresponding to the natural-language request; and cause the software platform to perform an operation based on the structured output.

The computing apparatus may also include where the structured output includes a settings-change output. The computing apparatus may also include where the settings-change output includes a plurality of requested settings changes parsed from the natural-language request. The computing apparatus may also include where the settings-change output includes data identify a data setting and a setting value for the data setting.

The computing apparatus may also include where the instructions further configure the apparatus to validate the structured output before causing the software platform to perform the operation. When validating, the computing apparatus may also include where the instructions further configure the apparatus to determine whether the structured output satisfies at least one of a security policy and a data integrity rule.

The computing apparatus may also include where the user interface includes a chat interface located on a landing page or within a resource of the software platform. Other technical features may be readily apparent to one skilled in the art from the following figures, descriptions, and claims.

In one aspect, a non-transitory computer-readable storage medium is provide, the computer-readable storage medium including instructions that when executed by a computer, cause the computer to: receive, via a user interface, a natural-language request associated with at least one data setting of a software platform; provide the natural-language request to a machine-learning model; receive, from the machine-learning model, a structured output corresponding to the natural-language request; and cause the software platform to perform an operation based on the structured output.

The non-transitory computer-readable storage medium may also include where the structured output includes a settings-change output. The non-transitory computer-readable storage medium may also include where the settings-change output includes a plurality of requested settings changes parsed from the natural-language request. The non-transitory computer-readable storage medium may also include where the settings-change output includes data identify a data setting and a setting value for the data setting.

The non-transitory computer-readable storage medium may also include where the instructions further configure the computer to validate the structured output before causing the software platform to perform the operation. When validating, the non-transitory computer-readable storage medium may also include where the instructions further configure the computer to determine whether the structured output satisfies at least one of a security policy and a data integrity rule.

The non-transitory computer-readable storage medium may also include where the user interface includes a chat interface located on a landing page or within a resource of the software platform. Other technical features may be readily apparent to one skilled in the art from the following figures, descriptions, and claims.

In one aspect, a computer-implemented method for processing a settings-related natural-language request in a software platform is provided, the method includes: receiving, via a user interface, a natural-language request associated with at least one data setting of the software platform; providing the natural-language request to a machine-learning model; receiving, from the machine-learning model, a structured output corresponding to the natural-language request; and causing the software platform to perform an operation based on the structured output.

The computer-implemented method may also include where the structured output includes a settings-change output. The computer-implemented method may also include where the settings-change output includes a plurality of requested settings changes parsed from the natural-language request. The computer-implemented method may also include where the settings-change output includes data identifying a data setting and a setting value for the data setting.

The computer-implemented method may also further include validating the structured output before causing the software platform to perform the operation. When validating, the computer-implemented method may also include where validating the structured output includes determining whether the structured output satisfies at least one of a security policy and a data integrity rule.

The computer-implemented method may also include where the user interface includes a chat interface located on a landing page or within a resource of the software platform. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for generative AI workflows for management of data settings., in accordance with one embodiment.

FIG. 2 illustrates a system architecture diagram in accordance with one embodiment.

FIG. 3 illustrates a block diagram in accordance with one embodiment.

FIG. 4 illustrates a routine for processing a settings-related natural-language request in a software platform in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

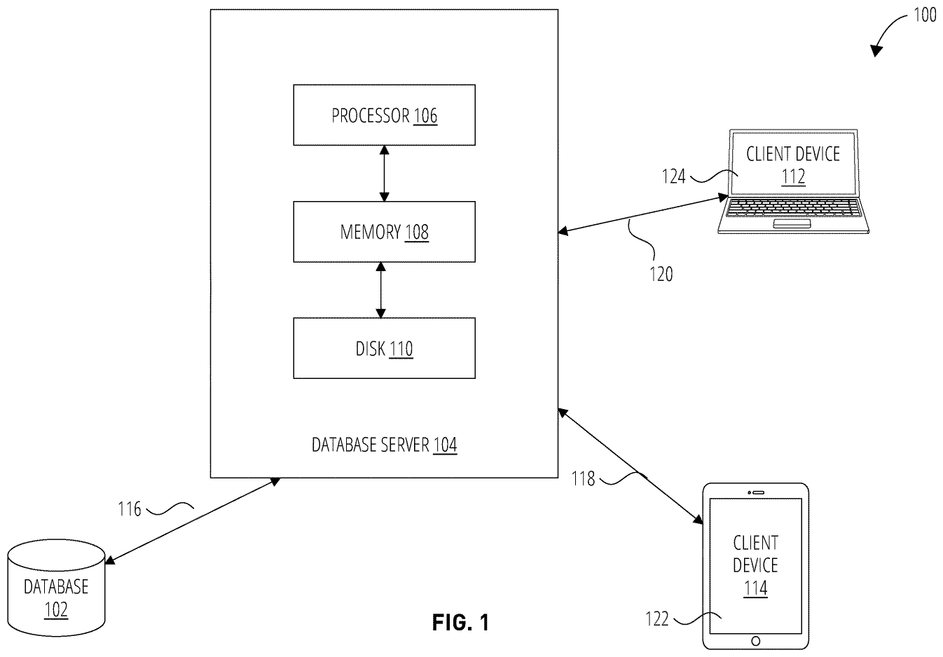

FIG. 1 illustrates an example of a system 100 for generative AI workflows for management of data settings.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

In the present disclosure, the terms “process” and “algorithm” are used interchangeably, and may refer to a set of steps performed in relation to an in-memory database, such as a versioned database. As referred to herein, for example, a deterministic process may be considered to be equivalent to a deterministic algorithm. A deterministic algorithm always produces the same output given a particular input. For example, an algorithm that always returns an output of Y with an input of X is deterministic. So, every time there is an input of X, it is known that the answer is Y. The result does not have to be unique, for example an input of Q can also return an output of Y, just deterministic. For a deterministic algorithm, once the input is known, the answer or output is already known, and it is not necessary to send the input to the algorithm at all.

In some implementations, a server memory may store an in-memory database as well as calculated results from processes or algorithms that are executed in relation to contents of the in-memory database. In some implementations, the calculated results may include about half of the server memory.

Reference to “in-memory” storage may refer to a server memory associated with database server 104, which may include memory 108 and/or database 102. Reference to “on-disk” storage may refer to disk 110 and/or other disks, for example disks associated with cloud storage.

In known approaches, both data (e.g. a versioned database) and calculations (e.g. calculated results) are stored in-memory. Such an approach is fast but also expensive. There is also a drawback that calculated results stored in-memory do not persist to disk when the server is restarted. The first time a calculation is performed, not only do all of the records need to be in-memory, but also the calculation structures must be built up in memory.

Embodiments of the present disclosure save memory and improve performance. Embodiments of the present disclosure avoid the time required to re-calculate the results, even the first time after server startup. Servers may have complicated invalidation rules. Even if something is stored in-memory, if the database changes, the results may be incorrect. Analytics results may also be lost from memory if the server detects that it is running out of memory. Embodiments of the present disclosure seek to solve one or more problems associated with known approaches, including wasted time and resources spent recalculating results.

A deterministic process as referred to herein may include an embedded algorithm, such as a supply chain algorithm used to analyze or calculate results based on an in-memory versioned database. An embedded algorithm may be implemented as a TypeScript algorithm. A deterministic process may include a core algorithm the results of which may not be serializable, for example if they are in-memory C++ objects that refer to other memories and other pointers.

Embodiments of the present disclosure may establish two tiers of storage, where the system may promote or demote a result. According to known approaches, some databases only exist in-memory, or only on-disk. Embodiments of the present disclosure provide a method of demoting content from in-memory to on-disk, or promoting content from on-disk to in-memory, for example in response to a server command or indication. If a result is not previously calculated, it can go from nowhere to in-memory or on-disk. In-memory is typically one tier, but on-disk can be one or more tiers. Embodiments of the present disclosure may be configured to provide an n-tier solution, for example where cloud storage provides different types of disks with different speeds of access, and the system may promote/demote to faster or slower disks in different on-disk tiers. Promoting/demoting refers to moving the results around, and is with respect to speed of access to the memory or disk(s).

To overcome difficulty of use of complex data settings panels and toolbars, systems and methods disclosed herein provide for construction of a new LLM-driven user experience that provides many benefits, such as: summary of data settings in a natural language; easy configuration of data settings with a natural language; chat with data; and secure data. Each benefit is briefly discussed below.

Summary of data settings in natural language allows for validation and summary of what a user is looking at, without having to navigate through the data settings. This also validates and summarizes data settings information in open resources. In addition, this can leverage help documentation to answer additional questions.

Easy configuration of data settings with natural language reduces clicks and searching. This allows for the optional use of voice. In addition, previous and current data settings usage can be recognized, leading to suggestions of appropriate settings.

Chat with data provides a low barrier to entry-that is, there is no need for extensive prior knowledge or training needed to succeed. This also respects access restrictions and preserves data security of resources. There is optional use of voice input.

Secure data results in the following: only a minimum required prompt is sent to LLM providers, and no proprietary information is exposed to third parties. In addition, the systems and methods disclosed herein respect access restrictions and preserve data security of resources.

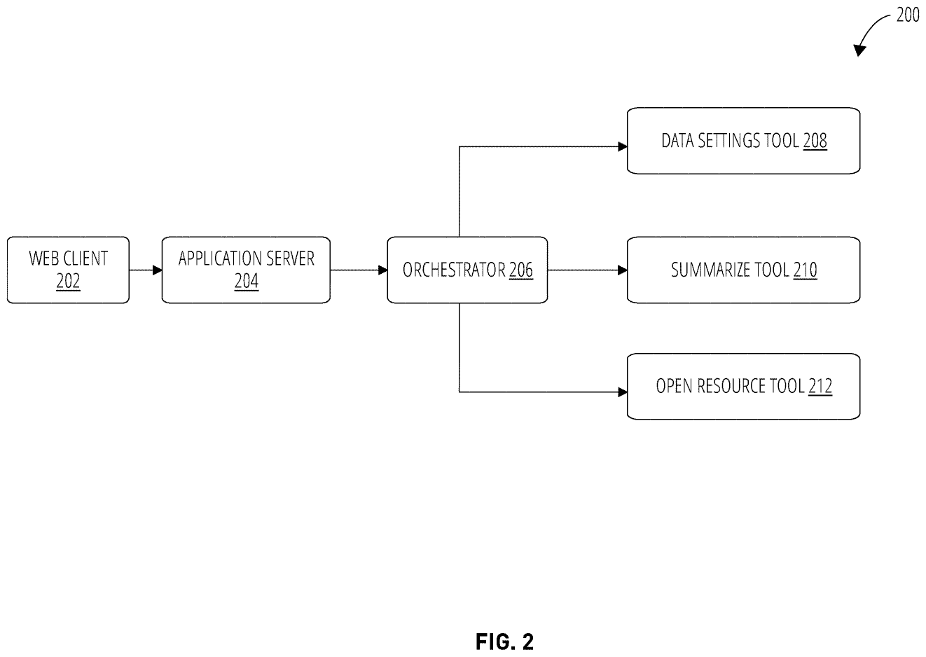

FIG. 2 illustrates a system architecture diagram 200 in accordance with one embodiment.

A solution can be built as follows. An out-of-box LLM can be used, with no additional training data. A new front-end addition to a web client 202 can be built, using existing technology (for example, React, TypeScript, and so forth). Next, endpoints may be added to an application server 204 to respond to user prompts; the endpoints may receive a prompt as a natural language statement.

An orchestrator 206 is used for the orchestration of prompts, which can be conducted as follows. The prompt is passed to an LLM with an orchestration system message (for example, ChatGPT, Gemini, or combinations thereof can be used). The system message tells the LLM it has tools to execute different requests. These requests can include, for example summarize settings, change settings, and open a resource. The system message then instructs the LLM to choose one of the tools by returning the tool name. Once the application server 204 receives a tool name, it can then call the agent with a system prompt specifying how to return the data to the user to perform the action.

A data settings prompt can be addressed as follows. If the data settings tool 208 is chosen, the LLM can be called, with the user prompt again; however a different system prompt is used that tells the LLM how to return data settings changes that are parsed out of the request. The message can contain descriptions for settings it can change, so it can return the settings change. As an example: {setting=“Scenario”, value=“Approved Actions”} .

A summarize settings prompt can be addressed as follows. If the summarize tool 210 is chosen, the LLM is called with the user prompt again, but with a different system prompt, that can tell the LLM about each setting with a description, so that the LLM can take the current settings state and summarize it as natural language.

An open resource prompt can be addressed as follows. If the open resource tool 212 is chosen, the LLM is called with the user prompt and a different system prompt, that tells the LLM about how to specify that the user resource should be opened. As an example: {name: “Planning Sheet”, type: “Workbook”} . Once the LLM responds, handlers for the tool responses can be added, to perform the actions and then reply to the user in the web client chat. Additionally, existing browser technology can be re-used to include voice-to-text, in order to handle voice commands.

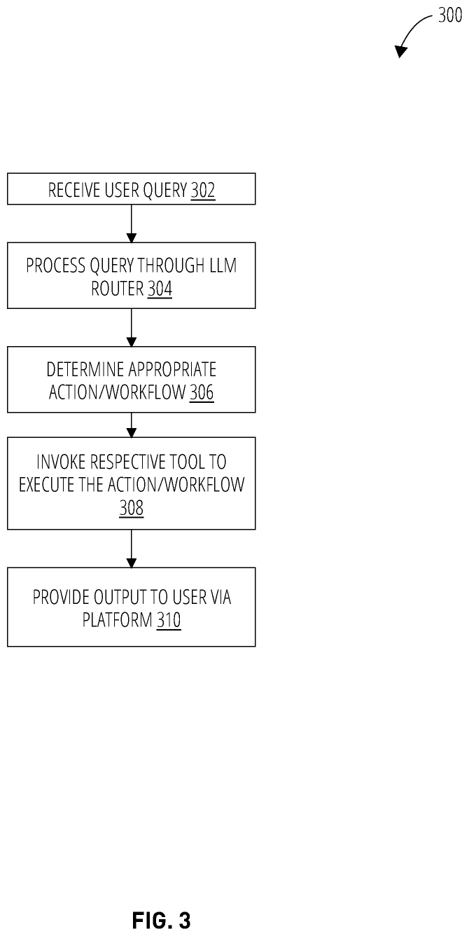

FIG. 3 illustrates a block diagram 300 in accordance with one embodiment.

Elements for a technical solution include: a chat interface on a landing page and inside resources; a set of data settings “tools” available for LLM's use; a router to parse and appropriately route an initial user query; and voice input integration.

These elements can be combined as follows. An initial user query (via text or voice) is received at block 302 through the chat interface. The query can then be processed through an LLM router (at block 304) to determine what action/workflow is the most appropriate in the given situation (at block 306). The LLM router can handle ambiguous queries where multiple actions may be valid. For example, there is a fallback option when the LLM does not match the intent of the query to one of the options provided. In addition, there can be a fallback mechanism if the LLM misinterprets the user's intent. For example, the query can be misinterpreted in many ways. The user can manually undo the change the LLM performed. If the change is invalid or cannot be performed because the LLM provided bad instructions, then an error message can be displayed to the user. Furthermore, the router can be trained to distinguish between setting changes and resource requests, by providing an initial prompt as context for the LLM to help it determine the user intent.

Based on a selected action, a specific tool is invoked to perform the workflow (at block 308). Examples of tools include a data settings tool, a summarize tool and open resource tool. Finally, the output is provided to the user via the platform user interface at block 310.

With respect to the natural language data settings tool, the system can validate that the parsed settings changes do not violate security policies or data integrity rules, as follows. The settings changes are routed through existing code that validates all of this and handles errors gracefully. The latency between the natural language input and the actual application of the setting change, is determined by the LLM, as the LLM is the only source of latency here. It returns new data settings as an object ready to by applied through the same endpoints a user would use in the Application Programming Interface (API). Conflicting instructions can be handled if a user provides contradictory parameters in a single prompt, as follows. Often such conflicting instructions can result in a validation issue when there is an attempt to apply the parameters. In some cases, where it might pass validation, the last setting can be chosen.

With respect to contextual summarization, the summarization tool can ensure it captures all critical nuances of a complex setting state without oversimplifying, as follows. An initial prompt/context provided to the LLM helps to control cases where the setting state might be oversimplified in the output by an LLM.

With respect to resource access, there are different types of metadata that can be used to uniquely identify a resource when multiple items share similar names. For example, the systems and methods disclosed herein support a tuple of [Resource type, resource name, resource scope]. Where both a public/private copy exist, preference may be given to the private scoped resource.

In addition, the system can handle permission checks when a user requests access to a resource they are not authorized to view, as follows. The system can go through existing web application mechanisms and can be handled the same way as a user who is attempting to do this manually would—that is, an error is displayed that indicates the resource cannot be accessed.

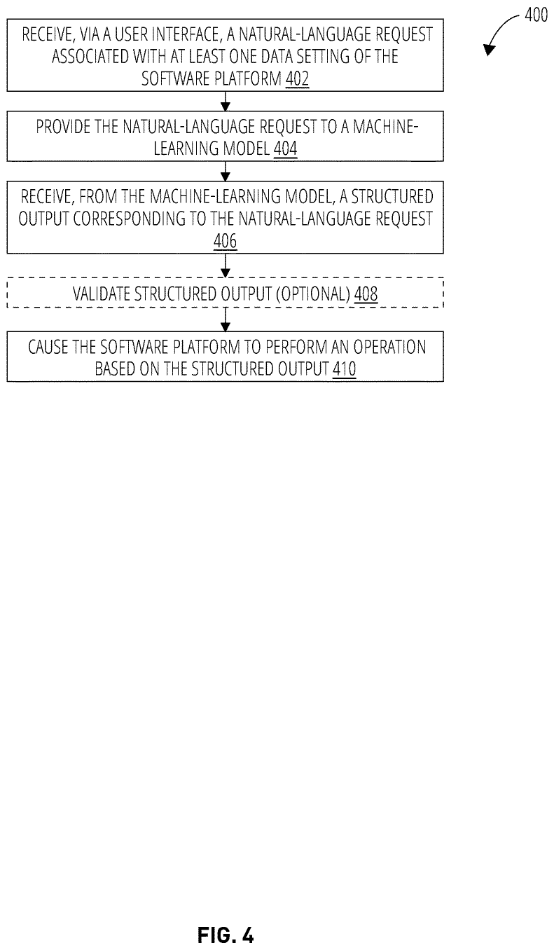

FIG. 4 illustrates a routine 400 for processing a settings-related natural-language request in a software platform in accordance with one embodiment.

In block 402, routine 400 receives, via a user interface, a natural-language request associated with at least one data setting of the software platform. The user interface can include a chat interface located on a landing page or within a resource of the software platform. The natural-language request can be generated from voice input using voice-to-text processing.

In block 404, routine 400 provides the natural-language request to a machine-learning model.

In block 406, routine 400 receives, from the machine-learning model, a structured output corresponding to the natural-language request. The structured output can include a settings-change output. Furthermore, the settings-change output can include a data identifying a data setting and a setting value for the data setting. The settings-change output can include a plurality of requested settings changes parsed from the natural-language request.

In block 410, there is an optional step of validating the structured output before causing the software platform to perform the operation. 2. Validating the structured output can include determining whether the structured output satisfies at least one of a security policy and a data integrity rule. Where the structured output fails validation, an error message can be displayed.

In block 410, routine 400 causes the software platform to perform an operation based on the structured output.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive, via a user interface of a software platform, a user input comprising a natural-language request;
process the natural-language request with a routing model to determine, from among a plurality of available workflows, a selected workflow corresponding to an intended action of the user;
based on the selected workflow, invoke a tool associated with the selected workflow;
generate, with a machine-learning model using the natural-language request and tool-specific instruction content associated with the tool, a tool output representing information for execution of the selected workflow;
cause the software platform to perform the selected workflow based on the tool output; and
provide, via the user interface, an output corresponding to the performed selected workflow.

2. The computing apparatus of claim 1, wherein the plurality of available workflows comprises a data settings workflow, a settings summarization workflow, and a resource access workflow.

3. The computing apparatus of claim 2, wherein the routing model is configured:
to select the data settings workflow when the natural-language request indicates a requested change to at least one data setting;
to select the settings summarization workflow when the natural-language request indicates a requested summary of a current settings state; and
to select the resource access workflow when the natural-language request indicates a requested opening of a user resource.

4. The computing apparatus of claim 1, wherein the tool-specific instruction content describes how the machine-learning model is to format the tool output for the selected workflow.

5. The computing apparatus of claim 1, wherein when generating the tool output, the apparatus is configured to:
transmit to the machine-learning model a minimum prompt content sufficient to perform the selected workflow.

6. The computing apparatus of claim 1, wherein when causing the software platform to perform the selected workflow, the apparatus is configured to:
pass the tool output to one or more handlers that execute the selected workflow through one or more application programming interface endpoints of the software platform.

7. The computing apparatus of claim 1, wherein when generating the tool output, the apparatus is configured to:
transmit to the machine-learning model a minimum prompt content sufficient to perform the selected workflow.

8. A non-transitory computer-readable storage medium, the computer-readable storage medium including instructions that when executed by a computer, cause the computer to:
receive, via a user interface of a software platform, a user input comprising a natural-language request;
process the natural-language request with a routing model to determine, from among a plurality of available workflows, a selected workflow corresponding to an intended action of the user;
based on the selected workflow, invoke a tool associated with the selected workflow;
generate, with a machine-learning model using the natural-language request and tool-specific instruction content associated with the tool, a tool output representing information for execution of the selected workflow;
cause the software platform to perform the selected workflow based on the tool output; and
provide, via the user interface, an output corresponding to the performed selected workflow.

9. The non-transitory computer-readable storage medium of claim 8, wherein the plurality of available workflows comprises a data settings workflow, a settings summarization workflow, and a resource access workflow.

10. The non-transitory computer-readable storage medium of claim 9, wherein the routing model is configured:
to select the data settings workflow when the natural-language request indicates a requested change to at least one data setting;
to select the settings summarization workflow when the natural-language request indicates a requested summary of a current settings state; and
to select the resource access workflow when the natural-language request indicates a requested opening of a user resource.

11. The non-transitory computer-readable storage medium of claim 8, wherein the tool-specific instruction content describes how the machine-learning model is to format the tool output for the selected workflow.

12. The non-transitory computer-readable storage medium of claim 8, wherein when generating the tool output, the computer is configured to:
transmit to the machine-learning model a minimum prompt content sufficient to perform the selected workflow.

13. The non-transitory computer-readable storage medium of claim 8, wherein when causing the software platform to perform the selected workflow, the computer is configured to:
pass the tool output to one or more handlers that execute the selected workflow through one or more application programming interface endpoints of the software platform.

14. The non-transitory computer-readable storage medium of claim 8, wherein when generating the tool output, the computer is configured to:
transmit to the machine-learning model a minimum prompt content sufficient to perform the selected workflow.

15. A computer-implemented method for managing data settings of a software platform, the method comprising:
receiving, via a user interface of the software platform, a user input comprising a natural-language request;
processing the natural-language request with a routing model to determine, from among a plurality of available workflows, a selected workflow corresponding to an intended action of the user;
based on the selected workflow, invoking a tool associated with the selected workflow;
generating, with a machine-learning model using the natural-language request and tool-specific instruction content associated with the tool, a tool output representing information for execution of the selected workflow;
causing the software platform to perform the selected workflow based on the tool output; and
provide, via the user interface, an output corresponding to the performed selected workflow.

16. The computer-implemented method of claim 15, wherein the plurality of available workflows comprises a data settings workflow, a settings summarization workflow, and a resource access workflow.

17. The computer-implemented method of claim 16, wherein the routing model is configured:
to select the data settings workflow when the natural-language request indicates a requested change to at least one data setting;
to select the settings summarization workflow when the natural-language request indicates a requested summary of a current settings state; and
to select the resource access workflow when the natural-language request indicates a requested opening of a user resource.

18. The computer-implemented method of claim 15, wherein the tool-specific instruction content describes how the machine-learning model is to format the tool output for the selected workflow.

19. The computer-implemented method of claim 15, wherein generating the tool output comprises transmitting to the machine-learning model a minimum prompt content sufficient to perform the selected workflow.

20. The computer-implemented method of claim 15, wherein causing the software platform to perform the selected workflow comprises passing the tool output to one or more handlers that execute the selected workflow through one or more application programming interface endpoints of the software platform.

21. The computer-implemented method of claim 15, wherein generating the tool output comprises transmitting to the machine-learning model a minimum prompt content sufficient to perform the selected workflow.
